(19) United States
(12) Patent Application Publication
(10) Pub. No.: US 2025/0029612 A1
(43) Pub. Date: Jan. 23, 2025

(54) GUIDING TRANSCRIPT GENERATION USING DETECTED SECTION TYPES AS PART OF AUTOMATIC SPEECH RECOGNITION

(71) Applicant: Amazon Technologies, Inc., Seattle, WA (US)

(72) Inventors: Lei Xu, Jersey City, NJ (US); Aparna Elangovan, Seattle, WA (US); Rohit Paturi, Newark, CA (US); Sundararajan Srinivasan, Mountain View, CA (US); Sravan BAbu Bodapati, Fremont, CA (US); Katrin Kirchoff, Seattle, WA (US); Sarthak Handa, Seattle, WA (US)

(73) Assignee: Amazon Technologies, Inc., Seattle, WA (US)

(21) Appl. No.: 18/356,117

(22) Filed: Jul. 20, 2023

(51) Int. Cl. G10L 15/26; G06F 40/20

(52) U.S. Cl. CPC G10L 15/26; G06F 40/20

(57) ABSTRACT

Transcript generation as part of automatic speech recognition may be guided using section types. Audio data is received for transcription. An initial transcript of the audio data may be generated and evaluated to determine a section type for the audio data. The section type may then be used to focus generation of a second version of the transcript on one speaker over another speaker.

### BACKGROUND

Automatic speech recognition (ASR) has now become tightly integrated with daily life through commonly used real-world applications such as digital assistants, news transcription and AI-based interactive voice response telephony. These real-world applications may include many different environments. In order to perform well in these different environments, ASR may have to adapt the ways in which transcripts are generated.

### BRIEF DESCRIPTION OF THE DRAWINGS

FIG. 1 illustrates a logical block diagram of guiding transcript generation using detected section types as part of automatic speech recognition, according to some embodiments.

FIG. 2 illustrates an example provider network that may implement a medical audio summarization service that implements guiding transcript generation using detected section types as part of automatic speech recognition, according to some embodiments.

FIG. 3 illustrates a logical block diagram of different interactions to perform text summarizations using guided transcript generation using detected section types as part of automatic speech recognition, according to some embodiments.

FIG. 4 illustrates a logical block diagram of an automatic speech recognition that generates transcripts and provides them with a section type to an NLP task, according to some embodiments.

FIGS. 5A-5C illustrate logical block diagrams of overlapping speakers in audio data and different transcript versions, according to some embodiments.

FIG. 6 illustrates a high-level flowchart of various methods and techniques to implement guiding transcript generation using detected section types as part of automatic speech recognition, according to some embodiments.

FIG. 7 illustrates an example system to implement the various methods, techniques, and systems described herein, according to some embodiments.

While embodiments are described herein by way of example for several embodiments and illustrative drawings, those skilled in the art will recognize that embodiments are not limited to the embodiments or drawings described. It should be understood, that the drawings and detailed description thereto are not intended to limit embodiments to the particular form disclosed, but on the contrary, the intention is to cover all modifications, equivalents and alternatives falling within the spirit and scope as described by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including, but not limited to.

It will also be understood that, although the terms first, second, etc. may be used herein to describe various elements, these elements should not be limited by these terms. These terms are only used to distinguish one element from another. For example, a first contact could be termed a second contact, and, similarly, a second contact could be termed a first contact, without departing from the scope of the present invention. The first contact and the second contact are both contacts, but they are not the same contact.

### DETAILED DESCRIPTION OF EMBODIMENTS

Various techniques for guiding transcript generation using detected section types as part of automatic speech recognition are described herein. Various scenarios of transcription using automatic speech recognition techniques may be misled by human speech patterns between multiple speakers when, for example, multiple speakers overlap In some applications of automatic speech recognition, such as in the healthcare domain, medical summaries of doctor-patient conversations may be generated that are transcribed using automatic speech recognition for recorded audio of clinical visits. The summaries capture a patient's reason for visit, history of illness as well as the doctor's assessment and plan for the patient. The summaries may be created using a special class of machine learning models, generative large language models (LLM) that are tuned to follow natural language instructions describing any task. This class of LLMs (e.g., InstructGPT) are typically trained on massive general-purpose text corpora and on a variety of tasks, including summarization.

In such applications, due to the nature of human conversation, there are often overlapping voices of both a patient and a doctor. Existing automatic speech recognition (ASR) systems may recognize the overlapping voices less accurately compared to when there is only one speaker. Also, complete sentences will be cut into incomplete spans because the other speaker is also speaking a few words at the same time, creating challenges for downstream summarization models or other natural language processing tasks. Thus, in various embodiments, the section type (e.g., the topic or type of conversation) may be used to guide the focus of automatic speech recognition (e.g., in an overlapping voices situation).

Consider the medical transcription example further. A medical consult session usually contains multiple sections, where each section has a different focus. For example, when the doctor is educating the patient with some medical facts, the patient's overlapping voice can be ignored; whereas if the doctor is asking a question, the patient saying words like “yeah” is critical to understand the conversation. Techniques for guiding transcript generation using detected section types as part of automatic speech recognition may recognize differences in section types in conversations (or other transcription scenarios) by running the transcript sectioning as part of ASR, and use the predicted section type to guide the focus of ASR (e.g., in the overlapping voice situation).

For instance, suppose audio data includes a conversation where:
Speaker A: The new drug
Speaker B: Yeah
Speaker A: is shown to be very effective. It
Speaker B: Okay
Speaker A: can reduce symptoms up to 90%.

In this conversation, ASR techniques may have trouble distinguishing speech on or near overlap between speakers. However, if techniques for guiding transcript generation using detected section types as part of automatic speech recognition are implemented, an educating section type can be detected, guiding ASR techniques to ignore Speaker B's speech for the educating section of the conversation when generating a transcript: Speaker A: The new drug is shown to be very effective. It can reduce symptoms up to 90%.

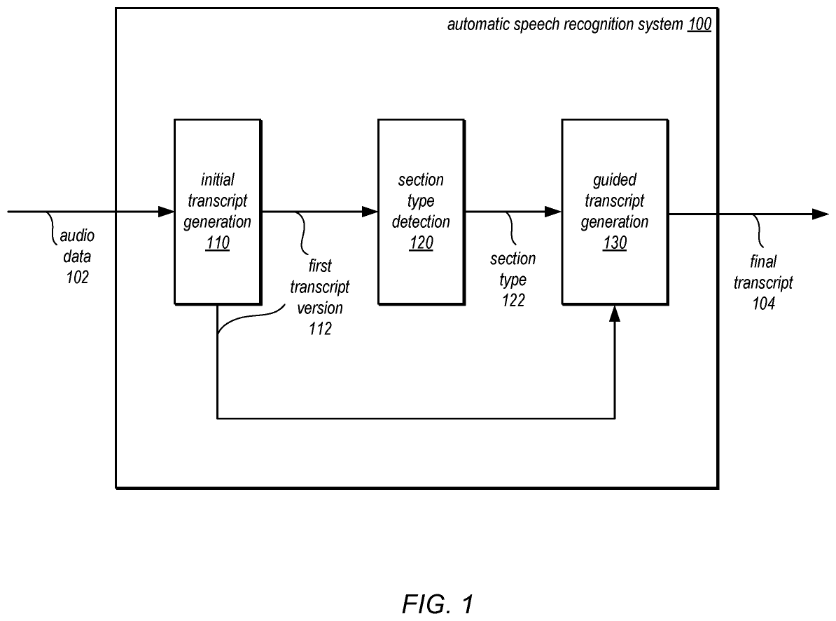

FIG. 1 illustrates a logical block diagram of guiding transcript generation using detected section types as part of automatic speech recognition, according to some embodiments. Automatic speech recognition system 100 may be a standalone automatic speech recognition system, or implemented as part of another system, application, that generates transcripts (e.g., a transcription service implemented as part of a provider network for various different domains, a natural language processing service implemented as part of a provider network that performs various tasks as directed according to transcripts generated by automatic speech recognition system 100, and/or a service that utilizes recognized speech, such as medical audio summary service 210 implemented as part of a provider network. Speech recognition system 100 may obtain audio data 102 (e.g., captured via an audio sensor, such as a microphone or other audio capture device) and generate a speech prediction that is a text prediction of words spoken in a human language in the audio data (or multiple speech predictions, such as may be performed by providing n-best speech predictions) as a final transcription 142 provided in response and/or for further natural language processing tasks.

Speech recognition system 100 may implement techniques for incorporating or otherwise utilizing detected section types for speech in audio data 102 as part of generating a second or final version of the transcript, as indicated at guided transcript generation, in various embodiments. For example, the audio data 102 may be processed through an acoustic feature extraction and speech recognition machine learning model that performs initial transcript generation 110, such as an non-autoregressive ASR model or, in some embodiments, an autoregressive ASR model, such as Recurrent Neural Network Transducer (RNN-T) or attention-based encoder-decoder (AED). The speech recognition machine learning model for initial transcription generation 110 may be trained to output token predictions (where a token corresponds to part of a word, a word, or multiple words in a language) that are the speech in the audio data, wherein the combined token predictions makeup the prediction of speech recognized in the audio data. As indicated at 112, different sequences of token predictions may be generated and output as possible text transcriptions, such as first transcript version 112 output to section type detection 120 and guided transcript generation 130.

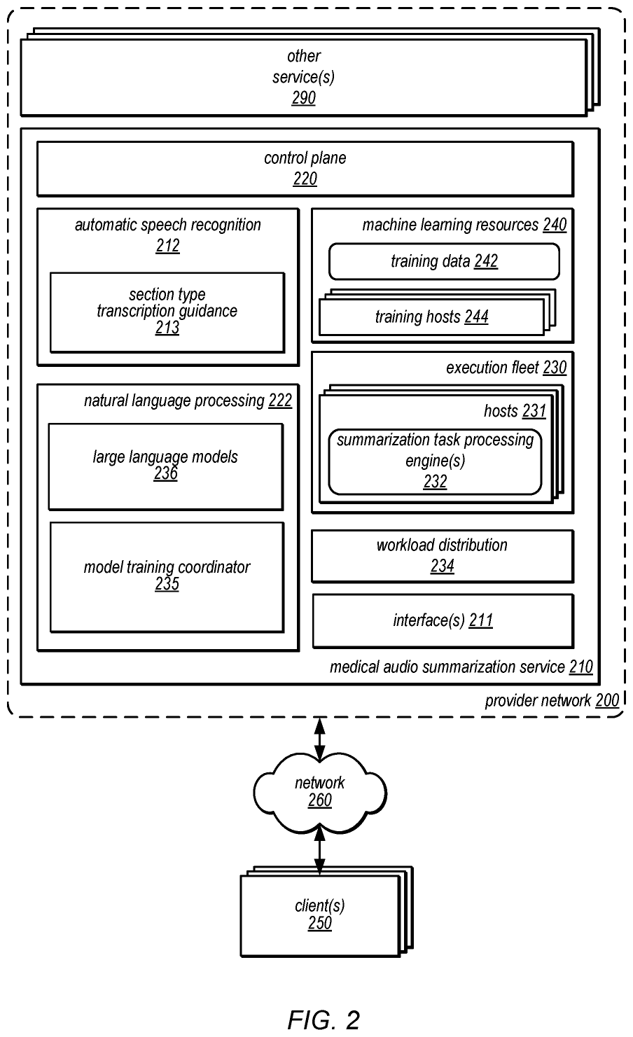

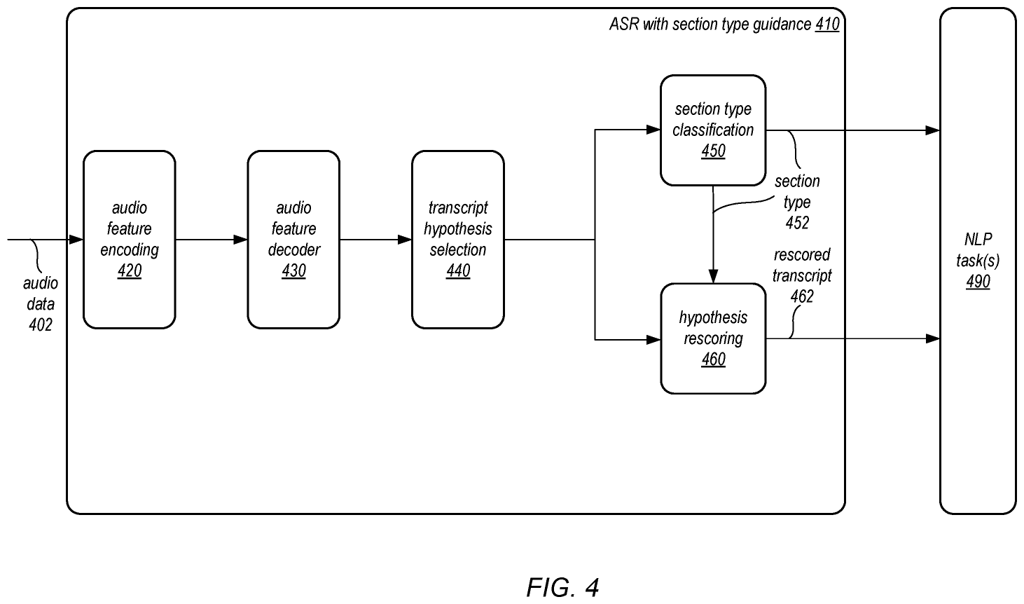

As discussed in detail below with regard to FIGS. 4 through 6, speech recognition system 100 may implement section type detection 120 to detect and provide a section type based on the first transcript version 112. For example, section type detection 120 may be performed in various ways using the transcript 112. For example, a machine learning model, such as neural network or other type of machine learning model, can be trained to predict a section type (e.g., a section type classifier-style machine learning model) given input text from a transcript. In some embodiments, a large language model (e.g., similar to those discussed below with regard to FIG. 2) may be used, such as by prompting the large language model to select between different section types given the first version of the transcript. Some machine learning models for section type detection that support few-shot or zero-shot tuning may allow for new section types to be included with audio data for generating the transcript. Various different section types may be supported. Some section types may be domain specific (e.g., specific to medical conversations, lectures/presentations, legal or legislative proceedings, etc.) or other section types may be general (e.g., applicable in various domains of transcription).

In various embodiments, guided transcript generation 130 may use the section type to modify (or re-generate first transcription version) to provide final transcript 104. For example, as discussed below with regard to FIG. 4, guided transcript generation may utilize rescoring to bias or otherwise weight certain speaker transcript portions more heavily when selecting between different hypothetical transcriptions. In some embodiments, the acoustic features may be reevaluated with the addition of the section type, using a machine learning model for speech recognition that is also trained to consider a section type that causes the machine learning model to bias in favor of certain speakers over others, in some scenarios.

Please note that the previous description of guiding transcript generation using detected section types as part of automatic speech recognition is a logical illustration and thus is not to be construed as limiting as to the implementation of an automatic speech recognition system.

This specification continues with a general description of a provider network that implements multiple different services, including a medical audio summarization service, which may implement guiding transcript generation using detected section types as part of automatic speech recognition. Then various examples of, including different components, or arrangements of components that may be employed as part of implementing the services are discussed. A number of different methods and techniques to implement guiding transcript generation using detected section types as part of automatic speech recognition are then discussed, some of which are illustrated in accompanying flowcharts. Finally, a description of an example computing system upon which the various components, modules, systems, devices, and/or nodes may be implemented is provided. Various examples are provided throughout the specification.

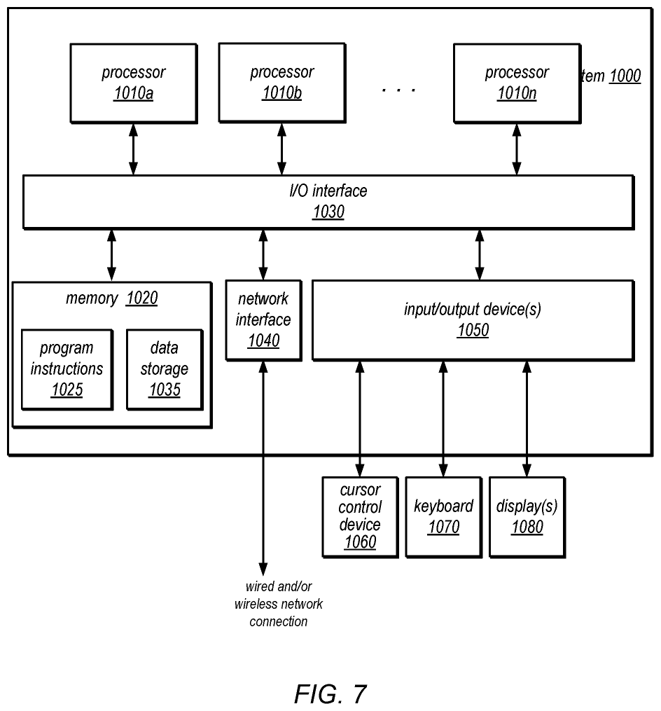

FIG. 2 illustrates an example provider network that may implement a medical audio summarization service that implements guiding transcript generation using detected section types as part of automatic speech recognition, according to some embodiments. In some embodiments, a provider network 200 may be a private or closed system or may be set up by an entity such as a company or a public sector organization to provide one or more services (such as various types of cloud-based storage or computing services) accessible via the Internet and/or other networks to clients 250, in some embodiments. The provider network 200 may be implemented in a single location or may include numerous data centers hosting various resource pools, such as collections of physical and/or virtualized computer servers, storage devices, networking equipment and the like (e.g., computing system 1000 described below with regard to FIG. 7), needed to implement and distribute the infrastructure and services offered by the provider network 200. For example, the provider network 200 may implement various computing resources or services, such as a medical audio summarization service 210, and/or any other type of network-based services 290 (which may include a virtual compute service and various other types of storage, database or data processing, analysis, communication, event handling, visualization, data cataloging, data ingestion (e.g., ETL), and security services), in some embodiments.

In various embodiments, the medical audio summarization service 100 may implement interface(s) 211 to allow clients (e.g., client(s) 250 or clients implemented internally within provider network 200, such as a client application hosted on another provider network service like an event driven code execution service or virtual compute service) to interact with the medical audio summarization service 210. The interface(s) 211 may be one or more of graphical user interfaces, programmatic interfaces that implement Application Program Interfaces (APIs) and/or command line interfaces, such as input interfaces, user setting interfaces, output interfaces, and/or output APIs.

In at least some embodiments, summarization task engine(s) 232 may be implemented on hosts 231 to initiate tasks for automatic speech recognition transcription 212 (with section type transcription guidance 213) and natural language processing 222. The workload distribution 234, comprising one or more computing devices, may be responsible for selecting the particular host 231 in execution fleet 230 that is to be used to implement a summarization task engine(s) 232 to be used to perform a given job. The medical audio summarization service 210 may implement control plane 220 to perform various control operations to implement the features of medical audio summarization service 210. For example, the control plane 220 may monitor the health and performance of computing resources (e.g., computing system 1000) used to perform tasks to service requests at different components, such as workload distribution 234, hosts 231, machine learning resources 240, automatic speech recognition transcription 212, and natural language processing engine 222. The control plane 220 may, in some embodiments, arbitrate, balance, select, or dispatch requests to different components in various embodiments.

The medical audio summarization service 210 may utilize machine learning resources 240. The machine learning resources 240 may include various frameworks, libraries, applications, or other tools for training or tuning machine learning models utilized as part of medical audio summarization service 210. For example, large language model 236 may be trained or fine-tuned (e.g., with domain-specific fine tuning).

Generally speaking, clients 250 may encompass any type of client that can submit network-based requests to provider network 200 via network 260, including requests for the medical audio summarization service 210 (e.g., a request to generate a transcript and summary of a medical conversation). For example, a given client 250 may include a suitable version of a web browser, or may include a plug-in module or other type of code module that can execute as an extension to or within an execution environment provided by a web browser.

In some embodiments, a client 250 may provide access to provider network 200 to other applications in a manner that is transparent to those applications. Clients 250 may convey network-based services requests (e.g., requests to interact with services like medical audio summarization service 210) via network 260, in some embodiments. In various embodiments, network 260 may encompass any suitable combination of networking hardware and protocols necessary to establish network-based-based communications between clients 250 and provider network 200. For example, network 260 may generally encompass the various telecommunications networks and service providers that collectively implement the Internet. Network 260 may also include private networks such as local area networks (LANs) or wide area networks (WANs) as well as public or private wireless networks, in one embodiment. For example, both a given client 250 and provider network 200 may be respectively provisioned within enterprises having their own internal networks. In such an embodiment, network 260 may include the hardware (e.g., modems, routers, switches, load balancers, proxy servers, etc.) and software (e.g., protocol stacks, accounting software, firewall/security software, etc.) necessary to establish a networking link between the given client 250 and the Internet as well as between the Internet and provider network 200. It is noted that in some embodiments, clients 250 may communicate with provider network 200 using a private network rather than the public Internet.

In some embodiments, medical audio summarization is performed, such as by a medical audio summarization service 210, and may resemble embodiments as shown in FIG. 2. In some embodiments, an input interface of the medical audio summarization service 210 may receive an indication of a medical conversation to be summarized (with various features, such as making a summary conforming to a user preferred style). In some embodiments, the input interface may receive an audio file including metadata of a medical conversation. For example, the input interface may receive an audio file of a doctor-patient conversation with metadata indicating that the conversation was in the context of a diabetes diagnosis. In some embodiments, a user, such as a physician, may upload a clinical visit audio between a patient and the physician to the input interface in order to generate a transcript and a summary based on the audio. The input interface may provide the audio file to an audio storage and also provide the metadata for the audio file to a metadata managing system. In some embodiments, a user of the medical audio summarization service 210 may indicate the medical conversation is to be summarized according to a preferred style by indicating a stored audio file in the audio storage for the medical audio summarization service 210 to summarize along with an indication of the preferred style. In some embodiments, the indication of the medical conversation to be summarized with the summary conforming to the user preferred summarization style may be a selection of the preferred summarization style from a set of available summarization styles. For example, the user may select as the user preferred style. For example, the style selection may be performed using a dropdown menu of the input interface that displays a list of available summarization styles. In some embodiments, the preferred summarization style may be indicated using a user provided summary sample. For example, the input interface may be configured to allow a user to upload (or otherwise indicate an uploaded one of) a medical conversation summary sample as an indication of the user preferred style. In some embodiments, the input interface may classify the user provided sample as one of a set of available summarization styles, wherein the classified style is used as the user preferred style. In some embodiments, the available summarization styles may be styles that a large language model has been trained to generate. For example, the available summarization styles may be summarization styles that the large language model 236 has been trained to generate. In some embodiments, a user setting interface may receive user preferences and/or user provided training data. For example, a user may indicate one or more summarization preference settings including a preferred style to be used as a default preferred style in the absence of a style selection and/or a user provided summary sample. In some embodiments, a customer may provide a sample medical conversation summary to use as the default preferred style, wherein summaries generated by the medical audio summarization service 210 are generated based on the user provided sample.

In some embodiments, the input interface may receive an indication of a medical conversation to be summarized and generate a job request, requesting a summary be generated for the medical conversation. The medical audio summarization service 210 may send the job request to summarization task processing engine 232. Once summarization task processing engine 232, receives the job request, summarization task processing engine 232 may access the audio file and the metadata of the medical conversation from the audio storage and the metadata managing system, respectively. A control plane 220 may send the job request to be queued to a job queue, in some embodiments. Automatic speech recognition transcription 212 may then process the job request from the job queue and generate a transcript of the medical conversation. For example, automatic speech recognition transcription 212 may be implemented end-to-end automatic speech recognition models based on Connectionist Temporal Classification (CTC) or other techniques, as discussed in detail below with regard to FIG. 4, which encode acoustic features from the audio data, generate possible transcriptions, select from among the possible transcriptions using one or more scoring techniques, apply section type transcript guidance 213, and then provide as the transcription the selected possible transcription (e.g., decoded from the encoded acoustic features). In some embodiments, the results may be provided cause a results notification. The results notification indicating generation of the transcript may be provided to the task summarization processing engine 232. In some embodiments, a first amount of audio data of the medical conversation may be provided to the automatic speech recognition transcription 212, while the patient and physician are still talking and generating a second (or subsequent) amount of the audio data (e.g., a real-time, live, or streaming scenario for medical audio summarization. For example, the medical conversation may be provided to the automatic speech recognition transcription 212 as an audio input stream. The transcript may be generated based on the first amount of audio data and the automatic speech recognition transcription 212 may receive the second amount of the audio data while continuing to generate the transcript. For example, the transcript may be generated during a clinical visit.

In some embodiments, a summarization task processing engine 232 may receive notification of a job request to generate a summary conforming to a user preferred style selected from a set of available styles (or no style at all). The summarization task processing engine 232 may also receive the transcript needed for the job request via a transcript retrieval interface. Notification of the job request and the transcript may be provided to a control plane 220 (or workload distribution 234) for the summarization task processing engine 232 and the job request and transcript may be provided to a job queue. A summarization task processing engine 232 may be instantiated by the control plane 220 and may receive the job request and the transcript from the job queue. In some embodiments, the summarization task processing engine 232 may then invoke machine learning models such as a medical entity detection model to identify medical entities and a role identification model to identify speaker roles, wherein the medical entity detection model and the role identification model are discretely trained for the specific entity detection/role identification. The workflow processing engine 130 may also invoke the large language model 236 to generate a summary, wherein the large language model takes as inputs outputs generated using the previous models. For example, summary inferences may be generated using the large language model and a transcript that has been marked with medical entities and speaker roles using the medical entity detection model and the role identification model.

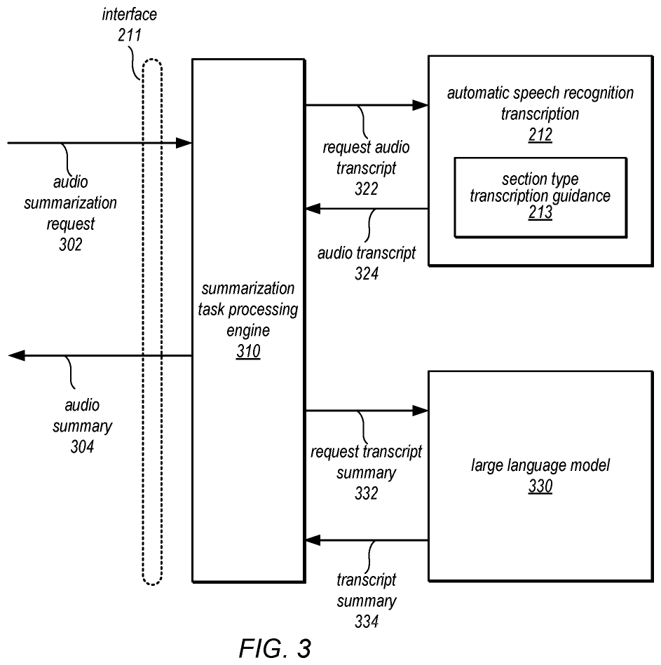

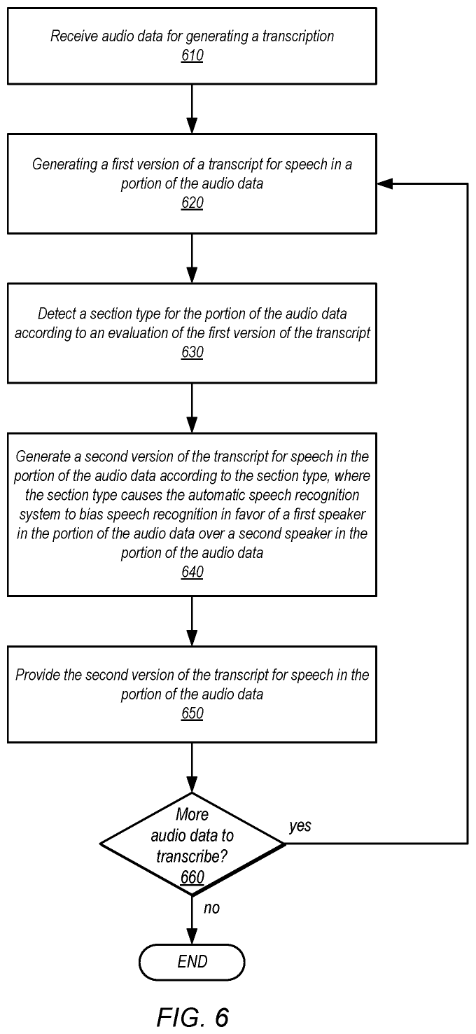

In some embodiments, a computing instance instantiated as a summarization task processing engine 232 may access respective ones of the models 236 with domain-specific fine-tuning to perform discrete tasks, such as medical entity detection, role identification, and various summarization tasks, such as sectioning, extraction, and abstraction. The summarization task processing engine 232 may merge results from each task into a current version of the transcript that is being updated as the discrete tasks are performed. The currently updated (and merged) version of the transcript may be used as an input to perform respective ones of the subsequent discrete tasks. For example, in some embodiments, the summarization task processing engine 232 may merge the results from a task performed using a prior model with the transcript and use the merged transcript to determine results for a task that uses the next model. For example, a workflow worker instance of the summarization task processing engine 232 may invoke a medical entity detection model to identify medical entities in a transcript. The results may then be merged with the transcript to include in the original transcript the identified medical entities. The workflow worker instance may then invoke the role identification model to identify speaker roles in the merged transcript. The identified speaker role results may then be merged with the merged transcript to include the identified medical entities and identified speaker roles. In some embodiments, the large language model 236 may generate a summary based on the updated version of the transcript and using domain specialty prompt instructions, as discussed in detail below with regard to FIGS. 3 and 6.

In some embodiments, the respective machine learning models may be used in different orders, but may be trained in whichever order the machine learning models are to be used. For example, in some embodiments, speaker role identification may be performed before medical entity identification, but in such a case, the medical entity identification model may be trained using training data this is output from the speaker role identification task. In other embodiments, medical entity identification may be performed prior to speaker role identification, in which case the speaker role identification model may be trained using training data that is output from the medical entity identification task. In some embodiments, the transcript may be merged with the results of a preceding model before being used for a future model.

In some embodiments, the language model 236 may perform one or more of the discrete tasks discussed above (such as medical entity detection, role identification, etc.) update to the transcript. The large language model 236 may perform multiple ones of a set of discrete tasks, such as sectioning, extraction, and abstraction, as a single script modification task. In some embodiments, the large language model 236 may perform additional ones of the discrete tasks discussed above, such as medical entity detection and role identification, and, in which case, directly use the transcript from the summarization task processing engine 232 to generate the summary.

In some embodiments, a model training coordinator 235 may be used for training the machine learning models with labeled training data, such as annotated transcripts. The model training coordinator 235 may use summarization style labeled training data 242 that comprise previously provided summaries and summary interaction metadata to train the large language model 236. In some embodiments, the model training coordinator 235 may be used offline.

Once the summary is generated, the summarization task processing engine 232 may provide the generated summary to an output interface. The output interface may notify the customer of the completed job request. In some embodiments, the output interface may provide a notification of a completed job to the output API. In some embodiments, the output API may be implemented to provide the summary for upload to an electronic health record (EHR) or may push the summary out to an electronic health record (EHR), in response to a notification of a completed job.

FIG. 3 illustrates a logical block diagram of different interactions to perform text summarizations using guided transcript generation using detected section types as part of automatic speech recognition, according to some embodiments. Summarization task processing engine 310 may receive requests via interface 211 (and workload distribution 234) for handling an audio summarization request 302. Audio summarization request 302 may request a specific domain as part of the request, such as medical summarization. In some embodiments, other summarization domains may be supported by service 210 (e.g., in addition to medical audio, such as legal, conference, or other transcription and summarization scenarios). Summarization task processing engine 310 may request audio transcript 322 from automatic speech recognition transcription 212, in some embodiments. Automatic speech recognition transcription 212 may utilize various audio processing techniques, such as deep neural network based speech recognition models as discussed in detail below with regard to FIG. 4 that utilize section type transcription guidance to generate an audio transcript of the audio data and provide the audio transcript 324 to summarization task processing engine 310.

Summarization task processing engine 310 may request 332 transcript summary from large language model 330 (which in some embodiments may be fine-tuned to a specific domain, such as medical), in some embodiments. The generated transcript summary 334 produced by large language model 330 may be returned and included in audio summary response 304.

FIG. 4 illustrates a logical block diagram of an automatic speech recognition that generates transcripts and provides them with a section type to an NLP task, according to some embodiments. ASR with section type guidance processing 410 (e.g., implemented on ASR resources 212 and 213 in FIG. 2) may implement audio feature encoding 420 to receive audio data 402 and provide acoustic features to audio feature decoder 430 (e.g., an ASR machine learning model). Different types of ASR machine learning models may be implemented, such as Hidden Markov models, neural networks, and/or end-to-end ASR techniques, such as connectionist temporal classification or attention-based models. In some embodiments, a number of possible transcripts may be generated by audio feature decoder 430, which are sometimes referred to as transcript hypotheses, which are provided to selection stage 440. Transcript hypothesis selection 440 may select a subset of the hypotheses (e.g., 1 transcript) according to transcript scores generated along with the hypotheses.

The selected transcript hypothesis may be provided to section type classification 440. Section types may be detected by section type classification 450 and may be domain-specific, such as the medical automatic speech recognition domain, in some embodiments. Examples of section types may include, but are not limited to, “educating,” “information gathering,” “assessing,” and/or “planning,” among other possible section types. In some embodiments, section types may correspond to different numbers of detected speakers or amounts of speaking time for different speakers. In some embodiments, section type evaluation may occur when different speakers overlap or speak in close time proximity (e.g., when speech for different speakers occurs simultaneously or in quick succession). Section type classification 450 may be implemented as a machine learning model, such as neural network or other type of machine learning model, be trained to predict a section type (e.g., a section type classifier-style machine learning model) given input text from a transcript. Training data for such machine learning models may include different examples of the different section types along with ground truth data that identifies the correct section type for the input transcript.

The detected section type 452 may be provided to hypothesis rescoring 460, in some embodiments. Hypothesis rescoring 460 may then implement rescoring techniques discussed in order to provide a rescored transcript to downstream NLP tasks 490. For instance, a section type may bias the weights or scores of transcription hypotheses in favor of one speaker over another (or in favor of one speaker for one time and another speaker for another time or pass of the audio data). As indicated in FIG. 4, in some embodiments the section type 452 may also be provide to NLP task(s) 490 in addition to rescored transcript 460. For instance, summary styles or templates may be utilized that correspond to the section type.

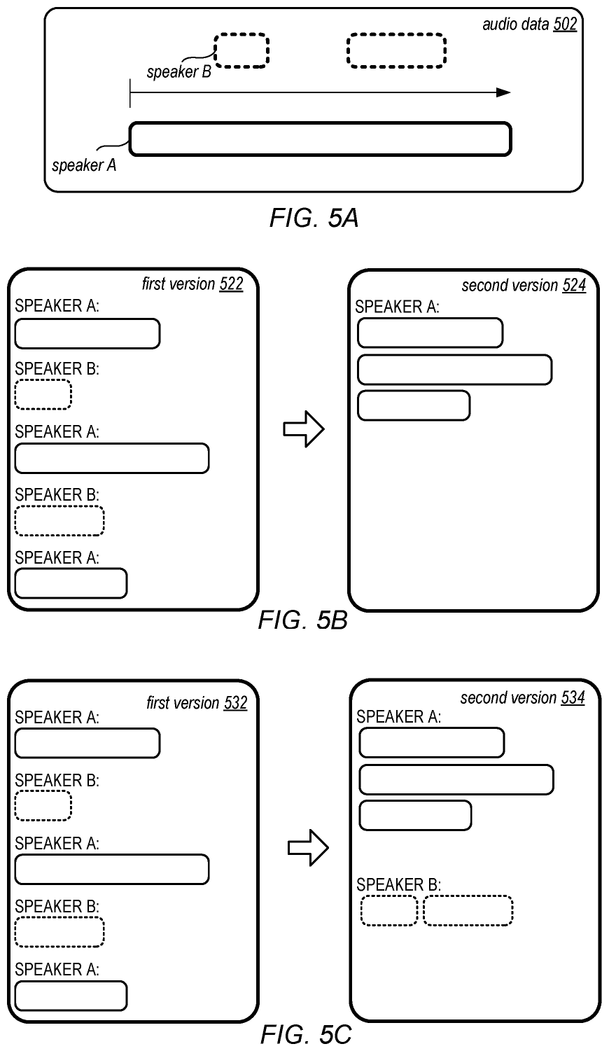

Different scenarios of partially or fully overlapping speech from different speakers (or speech from different speakers that follows in quick succession, such as speech that occurs in a pause in other speaker speech) may result in different forms of generating a different version of a transcript. For instance, in FIG. 5A, speaker A and speaker B may overlap at different points of a timeline of audio data 502. Different section types may result in different manipulations of speech in the second version generate according to the section type.

In FIG. 5B, for example, first version 522 may be a transcript that generates the different speaker speech in interleaving segments. However, if the section type indicates that Speaker A is the primary speaker, then transcription may be biased to Speaker A's speech and ignore, mute, or disregard Speaker B's speech. As indicated at second version 524, Speaker A's speech is retained and combined, while Speaker B's speech is not included in second version 524.

In FIG. 5C, for example, again first version 532 may be a transcript that generates the different speaker speech in interleaving segments. However, if the section type indicates that Speaker A and Speaker B are in a “planning” section type, then transcription may be biased to Speaker A's speech to group it together (e.g., to describe the plan) and then switch bias to Speaker B's speech to group it together (e.g., to describe the acknowledgement of the plan). As indicated at second version 534, Speaker A's speech is combined in one section of the second version 534 of the transcript and Speaker B's speech is combined in another portion of the second version 534.

Although FIGS. 2-5C have been described and illustrated in the context of a provider network implementing a medical audio summarization service, the various components illustrated and described in FIGS. 2-5C may be easily applied to other systems that implement automatic speech recognition and text analysis tasks, either standalone systems or implemented as a feature of a larger application, such as a transcription service or general natural language processing service that is not medical domain specific. As such, FIGS. 2-5C are not intended to be limiting as to other embodiments of guiding transcript generation using detected section types as part of automatic speech recognition.

FIG. 6 illustrates a high-level flowchart of various methods and techniques to implement guiding transcript generation using detected section types as part of automatic speech recognition, according to some embodiments. Various different systems and devices may implement the various methods and techniques described below, either singly or working together. Therefore, the above examples and or any other systems or devices referenced as performing the illustrated method, are not intended to be limiting as to other different components, modules, systems, or devices.

As indicated at 610, audio data may be received for generating a transcription, in some embodiments. For example, the audio data may be received as part of a system that performs speech recognition to generate a transcript alone. In other examples, the audio may be received as part of a large natural language processing pipeline, workflow, system, service, or application, which may provide a transcript generated for the audio data to perform other natural language processing tasks. The medical audio summary service discussed above with regard to FIGS. 4-5C, for instance, may be perform summary generation based on the transcript. Other natural language processing tasks for the same or other subjects or use cases (e.g., natural language processing tasks that trigger or perform actions based on the transcript) may receive the audio data.

As indicated at 620, a first version of a transcript may be generated for speech in a portion of the audio data, in some embodiments. For example, as discussed above with regard to FIGS. 1 and 4, various different types of ASR systems or techniques may be implemented. In some embodiments, Hidden Markov models, neural networks, end-to-end ASR techniques, such as connectionist temporal classification or attention-based models, may be used. In some embodiments, the audio data may be received in encoded form (e.g., encoded using a vocoder or other audio data codec). In some embodiments, the encoded audio data may be decoded in order to perform automatic speech recognition techniques. For instance, ASR techniques may perform upon audio data received as or decoded into waveforms or other signal representations. ASR techniques may recognize human speech in the audio data, including recognizing different speakers, and generate corresponding text of the human speech as the first version of the transcript.

As indicated at 630, a section type may be detected for the portion of the audio data according to an evaluation of the first version of the transcript, in some embodiments. Different section types may be supported by an automatic speech recognition system, in some embodiments. For example, section types may be domain-specific, such as the medical automatic speech recognition domain discussed above, that includes various section types like “educating,” “information gathering,” “assessing,” and/or “planning,” among other possible section types. In some embodiments, section types may correspond to different numbers of detected speakers or amounts of speaking time for different speakers, such as a “lecture/presentation” section type for a dominant speaker that speaks for long periods of time without interruption, or interruption by audience speech (e.g., laughter or applause) or a question and answer (Q&A) section type, where one speaker answers many different speakers. In some embodiments, section type evaluation may occur when different speakers overlap or speak in close time proximity (e.g., when speech for different speakers occurs simultaneously or in quick succession).

Section type detection may be performed in various ways using the transcript. For example, a machine learning model, such as neural network or other type of machine learning model, can be trained to predict a section type (e.g., a section type classifier-style machine learning model) given input text from a transcript. Training data for such machine learning models may include different examples of the different section types along with ground truth data that identifies the correct section type for the input transcript. In some embodiments, a large language model may be used, such as by prompting the large language model to select between different section types given the first version of the transcript. Some machine learning models that support few-shot or zero-shot tuning may allow for new section types to be included with audio data for generating the transcript. As discussed above with regard to FIG. 3, in some embodiments, the request to perform a natural language task or generate a transcript, as indicated in FIG. 4, may include a selection or specification of section types. Alternatively, a separate interface for an automatic speech recognition system may support specifying section types, adding section types, removing section types, or otherwise controlling which section types may be utilized for guiding transcription. Such requests may trigger various workflows to update, remove, or otherwise make corresponding changes to section type detection techniques in order to accommodate the specified section types (e.g., switching section type classifiers according to the type of transcription domain).

As indicated at 640, a second version of the transcript for speech in the portion of the audio data according to the section type, in some embodiments. The section type may cause the automatic speech recognition system to bias speech recognition in favor of a first speaker in the portion of the audio data over a second speaker in the portion of the audio data, in some embodiments. For example, the section type may correspond to single speaker scenarios, where other detected speakers are muted or ignored, as discussed above with regard to FIG. 5B. In some embodiments, bias in favor of one speaker may allow for reordering or other manipulation of the detected speech (e.g., in one or multiple passes) to organize the transcript according to the section type, as discussed above with regard to FIG. 5C. Biasing toward speakers may include re-performing the same ASR techniques above with an additional input for section type, or may involve using the section type to reweight, rescore, or refine the transcript version (e.g., by changing which hypothetical transcriptions may be selected using the section type to rescore hypothetical transcriptions).

As indicated at 650, the second version of the transcript for speech in the portion of the audio data may be provided, in some embodiments. For example, the second version of the transcript may be stored for subsequent access or provided directly to another system, such as a system that performs natural language processing tasks on the second version of the transcript. In at least some embodiments, the section type may be provided in addition to the second version of the transcript (e.g., to influence or alter downstream processing, such as storage location or how natural language processing tasks are performed).

As indicated at 660, if further audio data is to be obtained, the technique may be repeated. For this further audio data, a change in section type may be detected. In this way, the transcription technique may change when corresponding changes occur in the audio data. For instance, the audio data may change from an “education” section type to a “Q&A” section type. This change may be detected according to an additional first version transcript generated for the further audio data. When no further audio data is to be transcribed, then the technique may end, as indicated by the negative exit from 660. These techniques may support both real-time transcription (e.g., receiving audio data as part of an audio stream capture and sent to the automatic speech recognition system, which may determine the section type for a portion of the conversation or audio being recorded and another section type for later portion of the conversation or audio when it is received) or may operate on previously captured and completed audio data (e.g., previously recorded conversations or other communications for transcription which may be collected as group of different audio files and provided as a batch to an automatic speech recognition to generate different respective transcripts for each audio file in the batch).

The methods described herein may in various embodiments be implemented by any combination of hardware and software. For example, in one embodiment, the methods may be implemented on or across one or more computer systems (e.g., a computer system as in FIG. 7) that includes one or more processors executing program instructions stored on one or more computer-readable storage media coupled to the processors. The program instructions may implement the functionality described herein (e.g., the functionality of various servers and other components that implement the network-based virtual computing resource provider described herein). The various methods as illustrated in the figures and described herein represent example embodiments of methods. The order of any method may be changed, and various elements may be added, reordered, combined, omitted, modified, etc.

Embodiments of guiding transcript generation using detected section types as part of automatic speech recognition as described herein may be executed on one or more computer systems, which may interact with various other devices. One such computer system is illustrated by FIG. 7. In different embodiments, computer system 1000 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing device, computing node, compute node, or electronic device.

In the illustrated embodiment, computer system 1000 includes one or more processors 2110 coupled to a system memory 1020 via an input/output (I/O) interface 1030. Computer system 1000 further includes a network interface 1040 coupled to I/O interface 1030, and one or more input/output devices 1050, such as cursor control device 1060, keyboard 1070, and display(s) 1080. Display(s) 1080 may include standard computer monitor(s) and/or other display systems, technologies or devices. In at least some implementations, the input/output devices 1050 may also include a touch- or multi-touch enabled device such as a pad or tablet via which a user enters input via a stylus-type device and/or one or more digits. In some embodiments, it is contemplated that embodiments may be implemented using a single instance of computer system 1000, while in other embodiments multiple such systems, or multiple nodes making up computer system 1000, may host different portions or instances of embodiments. For example, in one embodiment some elements may be implemented via one or more nodes of computer system 1000 that are distinct from those nodes implementing other elements.

In various embodiments, computer system 1000 may be a uniprocessor system including one processor 2110, or a multiprocessor system including several processors 2110 (e.g., two, four, eight, or another suitable number). Processors 2110 may be any suitable processor capable of executing instructions. For example, in various embodiments, processors 2110 may be general-purpose or embedded processors implementing any of a variety of instruction set architectures (ISAs), such as the x86, PowerPC. SPARC, or MIPS ISAs, or any other suitable ISA. In multiprocessor systems, each of processors 2110 may commonly, but not necessarily, implement the same ISA.

In some embodiments, at least one processor 2110 may be a graphics processing unit. A graphics processing unit or GPU may be considered a dedicated graphics-rendering device for a personal computer, workstation, game console or other computing or electronic device. Modern GPUs may be very efficient at manipulating and displaying computer graphics, and their highly parallel structure may make them more effective than typical CPUs for a range of complex graphical algorithms. For example, a graphics processor may implement a number of graphics primitive operations in a way that makes executing them much faster than drawing directly to the screen with a host central processing unit (CPU). In various embodiments, graphics rendering may, at least in part, be implemented by program instructions that execute on one of, or parallel execution on two or more of, such GPUs. The GPU(s) may implement one or more application programmer interfaces (APIs) that permit programmers to invoke the functionality of the GPU(s). Suitable GPUs may be commercially available from vendors such as NVIDIA Corporation, ATI Technologies (AMD), and others.

System memory 1020 may store program instructions and/or data accessible by processor 2110. In various embodiments, system memory 1020 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing desired functions, such as ratio mask post-filtering for audio enhancement as described above are shown stored within system memory 1020 as program instructions 1025 and data storage 1035, respectively. In other embodiments, program instructions and/or data may be received, sent or stored upon different types of computer-accessible media or on similar media separate from system memory 1020 or computer system 1000. Generally speaking, a non-transitory, computer-readable storage medium may include storage media or memory media such as magnetic or optical media, e.g., disk or CD/DVD-ROM coupled to computer system 1000 via I/O interface 1030. Program instructions and data stored via a computer-readable medium may be transmitted by transmission media or signals such as electrical, electromagnetic, or digital signals, which may be conveyed via a communication medium such as a network and/or a wireless link, such as may be implemented via network interface 1040.

In one embodiment, I/O interface 1030 may coordinate I/O traffic between processor 2110, system memory 1020, and any peripheral devices in the device, including network interface 1040 or other peripheral interfaces, such as input/output devices 1050. In some embodiments, I/O interface 1030 may perform any necessary protocol, timing or other data transformations to convert data signals from one component (e.g., system memory 1020) into a format suitable for use by another component (e.g., processor 2110). In some embodiments, I/O interface 1030 may include support for devices attached through various types of peripheral buses, such as a variant of the Peripheral Component Interconnect (PCI) bus standard or the Universal Serial Bus (USB) standard, for example. In some embodiments, the function of I/O interface 1030 may be split into two or more separate components, such as a north bridge and a south bridge, for example. In addition, in some embodiments some or all of the functionality of I/O interface 1030, such as an interface to system memory 1020, may be incorporated directly into processor 2110.

Network interface 1040 may allow data to be exchanged between computer system 1000 and other devices attached to a network, such as other computer systems, or between nodes of computer system 1000. In various embodiments, network interface 1040 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 1050 may, in some embodiments, include one or more display terminals, keyboards, keypads, touchpads, scanning devices, voice or optical recognition devices, or any other devices suitable for entering or retrieving data by one or more computer system 1000. Multiple input/output devices 1050 may be present in computer system 1000 or may be distributed on various nodes of computer system 1000. In some embodiments, similar input/output devices may be separate from computer system 1000 and may interact with one or more nodes of computer system 1000 through a wired or wireless connection, such as over network interface 1040.

As shown in FIG. 7, memory 1020 may include program instructions 1025, that implement the various methods and techniques as described herein, including the application of self-supervised training for audio anomaly detection and data storage 1035, comprising various data accessible by program instructions 1025. In one embodiment, program instructions 1025 may include software elements of embodiments as described herein and as illustrated in the Figures. Data storage 1035 may include data that may be used in embodiments. In other embodiments, other or different software elements and data may be included.

Those skilled in the art will appreciate that computer system 1000 is merely illustrative and is not intended to limit the scope of the techniques as described herein. In particular, the computer system and devices may include any combination of hardware or software that can perform the indicated functions, including a computer, personal computer system, desktop computer, laptop, notebook, or netbook computer, mainframe computer system, handheld computer, workstation, network computer, a camera, a set top box, a mobile device, network device, internet appliance, PDA, wireless phones, pagers, a consumer device, video game console, handheld video game device, application server, storage device, a peripheral device such as a switch, modem, router, or in general any type of computing or electronic device. Computer system 1000 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a non-transitory, computer-accessible medium separate from computer system 1000 may be transmitted to computer system 1000 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the present invention may be practiced with other computer system configurations.

It is noted that any of the distributed system embodiments described herein, or any of their components, may be implemented as one or more web services. In some embodiments, a network-based service may be implemented by a software and/or hardware system designed to support interoperable machine-to-machine interaction over a network. A network-based service may have an interface described in a machine-processable format, such as the Web Services Description Language (WSDL). Other systems may interact with the web service in a manner prescribed by the description of the network-based service's interface. For example, the network-based service may describe various operations that other systems may invoke, and may describe a particular application programming interface (API) to which other systems may be expected to conform when requesting the various operations.

In various embodiments, a network-based service may be requested or invoked through the use of a message that includes parameters and/or data associated with the network-based services request. Such a message may be formatted according to a particular markup language such as Extensible Markup Language (XML), and/or may be encapsulated using a protocol such as Simple Object Access Protocol (SOAP). To perform a web services request, a network-based services client may assemble a message including the request and convey the message to an addressable endpoint (e.g., a Uniform Resource Locator (URL)) corresponding to the web service, using an Internet-based application layer transfer protocol such as Hypertext Transfer Protocol (HTTP).

In some embodiments, web services may be implemented using Representational State Transfer (“RESTful”) techniques rather than message-based techniques. For example, a web service implemented according to a RESTful technique may be invoked through parameters included within an HTTP method such as PUT, GET, or DELETE, rather than encapsulated within a SOAP message.

The various methods as illustrated in the FIGS. and described herein represent example embodiments of methods. The methods may be implemented in software, hardware, or a combination thereof. The order of method may be changed, and various elements may be added, reordered, combined, omitted, modified, etc.

Various modifications and changes may be made as would be obvious to a person skilled in the art having the benefit of this disclosure. It is intended that the invention embrace all such modifications and changes and, accordingly, the above description to be regarded in an illustrative rather than a restrictive sense.

What is claimed is:

1. A system, comprising:
one or more computing devices, respectively comprising a processor and a memory, that implement an automatic speech recognition system as part of a service of a provider network, wherein the automatic speech recognition system is configured to:
receive audio data for generating a transcription;
generate a first version of a transcript for speech in a portion of the audio data according to a machine learning model trained to recognize the speech in the portion of the audio data, wherein the portion of the audio data includes overlapping speech between a first speaker and a second speaker;
select a section type for the portion of the audio data out of a plurality of possible section types according to an evaluation of the first version of the transcript;
generate a second version of the transcript for speech in the portion of the audio data according to the section type, wherein the section type causes the generating the second version of the transcript to bias speech recognition in favor of the first speaker in the portion of the audio data over the second speaker in the portion of the audio data; and
provide the second version of the transcript for speech in the portion of the audio data.

2. The system of claim 1, wherein the section type is provided along with the second version of the transcript to a system that performs a downstream natural language processing task.

3. The system of claim 1, wherein the automatic speech recognition system is further configured to:
receive further audio data;
generate a first version of a transcript for speech in the further audio data according to the machine learning model;
select a different section type for the further audio data out of the plurality of possible section types according to an evaluation of the first version of the transcript of the further audio data;
generate a second version of the transcript for speech in the further audio data according to the different section type; and
provide the second version of the transcript for speech in the further audio data.

4. The system of claim 1, wherein the service of the provider network is a medical audio summary service, wherein then audio data is identified according to a request to summarize the audio data received via an interface of the medical audio summary service, and wherein the second version of the transcript is provided to an audio summarization task that generates a summary of the audio data.

5. A method, comprising:
receiving, at an automatic speech recognition system, audio data for generating a transcription;
generating, by the automatic speech recognition system, a first version of a transcript for speech in a portion of the audio data;
detecting, by the automatic speech recognition system, a section type for the portion of the audio data according to an evaluation of the first version of the transcript;
generating, by the automatic speech recognition system, a second version of the transcript for speech in the portion of the audio data according to the section type, wherein the section type causes the automatic speech recognition system to bias speech recognition in favor of a first speaker in the portion of the audio data over a second speaker in the portion of the audio data; and
providing, by the automatic speech recognition system, the second version of the transcript for speech in the portion of the audio data.

6. The method of claim 5, wherein the section type is provided along with the second version of the transcript to a system that performs a downstream natural language processing task.

7. The method of claim 5, wherein the audio data is received as part of a batch of audio files for generating respective transcriptions for individual ones of the audio files in the batch.

8. The method of claim 5, wherein the audio data is received as part of a stream of audio data for performing real-time transcription on the stream of audio data.

9. The method of claim 5, wherein the section type is one of a plurality of section types that are specified in a request to the automatic speech recognition system for performing transcription.

10. The method of claim 5, wherein the second version of the transcript combines different sections of text spoken by the first speaker and interleaved with further sections of further text spoken by the second speaker.

11. The method of claim 5, wherein generating the second version of the transcript for speech in the portion of the audio data according to the section type comprises rescoring one or more hypothetical transcriptions using the section type.

12. The method of claim 5, further comprising:
receiving, at the automatic speech recognition system, further audio data;
generating, by the automatic speech recognition system, a first version of a transcript for speech in the further audio data;
detecting, by the automatic speech recognition system, a different section type for the further audio data according to an evaluation of the first version of the transcript for the further audio data;
generating, by the automatic speech recognition system, a second version of the transcript for speech in the further audio data according to the different section type; and
providing, by the automatic speech recognition system, the second version of the transcript for speech in the further audio data.

13. The method of claim 5, wherein the audio data is received according to a request to generate the transcript for the audio data, wherein the automatic speech recognition system is implemented as a transcription service of a provider network, and wherein the request is received via an interface of the transcription service.

14. One or more non-transitory, computer-readable storage media, storing program instructions that when executed on or across one or more computing devices cause the one or more computing devices to implement:
receiving audio data for generating a transcription;
generating a first version of a transcript for speech in a portion of the audio data according to a machine learning model trained to recognize the speech in the portion of the audio data;
detecting a section type for the portion of the audio data according to an evaluation of the first version of the transcript;
generating a second version of the transcript for speech in the portion of the audio data according to the section type, wherein the section type causes the generating the second version of the transcript to bias speech recognition in favor of a first speaker in the portion of the audio data over a second speaker in the portion of the audio data; and
providing the second version of the transcript for speech in the portion of the audio data.

15. The one or more non-transitory, computer-readable storage media of claim 14, wherein the section type is provided along with the second version of the transcript to a system that performs a downstream natural language processing task.

16. The one or more non-transitory, computer-readable storage media of claim 14, wherein the audio data is received as part of a batch of audio files for generating respective transcriptions for individual ones of the audio files in the batch.

17. The one or more non-transitory, computer-readable storage media of claim 14, wherein the second version of the transcript discards one or more sections of text spoken by the second speaker.

18. The one or more non-transitory, computer-readable storage media of claim 14, wherein, in generating the second version of the transcript for speech in the portion of the audio data according to the section type, the program instructions cause the one or more computing devices to implement rescoring one or more hypothetical transcriptions using the section type.

19. The one or more non-transitory, computer-readable storage media of claim 14, storing further program instructions that when executed, cause the one or more computing devices to further implement:
receiving further audio data;
generating a first version of a transcript for speech in the further audio data;
detecting a different section type for the further audio data according to an evaluation of the first version of the transcript for the further audio data;
generating a second version of the transcript for speech in the further audio data according to the different section type; and
providing the second version of the transcript for speech in the further audio data.

20. The one or more non-transitory, computer-readable storage media of claim 14, wherein the one or more computing devices are implemented as part of a medical audio summary service offered by a provider network, wherein then audio data is identified according to a request to summarize the audio data received via an interface of the medical audio summary service, and wherein the second version of the transcript is provided to an audio summarization task that generates a summary of the audio data.
